(19) United States
(12) Patent Application Publication
(10) Pub. No.: US 2024/0257597 A1
(43) Pub. Date: Aug. 1, 2024

(54) SHEET HANDLING DEVICE AND SHEET HANDLING METHOD

(71) Applicant: Glory Ltd., Himeji-shi (JP)

(72) Inventor: Yoshitomo MINAMI, Himeji-shi (JP)

(73) Assignee: Glory Ltd., Himeji-shi (JP)

(21) Appl. No.: 18/407,475

(22) Filed: Jan. 9, 2024

(30) Foreign Application Priority Data
Jan. 27, 2023 (JP) 2023-011025

(51) Int. Cl. G07D 11/23; G07D 11/14; G07D 11/18

(52) U.S. Cl. CPC G07D 11/23; G07D 11/14; G07D 11/18; G07D 2211/00

(57) ABSTRACT

A sheet handling device disclosed here includes a receiving port, a transport mechanism that transports a sheet received into a housing through the receiving port, and a recognition circuit having a first passing port and a second passing port through which the sheet transported by the transport mechanism passes and recognizing the sheet passing the first passing port and the second passing port. The first passing port is positioned apart from the receiving port in a first direction. The transport mechanism has a first path which is part of a transport path connecting the receiving port and the first passing port to each other. The first path is inclined, with respect to the first direction, apart from the first passing port while extending from the receiving port to the first passing port.

### CROSS-REFERENCE TO RELATED APPLICATION

This application claims priority to Japanese Patent Application No. 2023-011025 filed on Jan. 27, 2023, the entire disclosure of which is incorporated by reference herein.

### BACKGROUND

The technique disclosed here relates to a sheet handling device and a sheet handling method.

In a conventional banknote depositing and dispensing machine, a first transport unit is arranged on one side in a direction perpendicular to the direction of arrangement of a depositing unit, a withdrawal unit, a collection container, and a withdrawal reject container in a first component group collectively including the depositing unit, the withdrawal unit, the collection container, and the withdrawal reject container, a second transport unit is arranged on the side opposite to the one side in a second component group collectively including a plurality of recycle containers, and a third transport unit connecting the first transport unit and the second transport unit to each other is arranged between the first component group and the second component group.

### SUMMARY

The technique disclosed here relates to a sheet handling device. The sheet handling device includes
a receiving port that receives a sheet into a housing,
a transport mechanism that transports the sheet received into the housing through the receiving port and
a recognition circuit that has a first passing port and a second passing port through which the sheet transported by the transport mechanism passes and recognizes the sheet passing the first passing port and the second passing port.

The first passing port of the recognition circuit is positioned apart from the receiving port in a first direction,
the transport mechanism has a first path which is part of a transport path connecting the receiving port and the first passing port to each other, and
the first path is inclined, with respect to a first reference line extending in the first direction, apart from the first passing port while extending from the receiving port to the first passing port.

### BRIEF DESCRIPTION OF THE DRAWINGS

FIG. 1 shows an internal structure of a sheet handling device.

FIG. 2 is a block diagram of the sheet handling device.

FIG. 3 shows an example of divided drive systems of the sheet handling device.

FIG. 4 shows a banknote transport path in depositing processing.

FIG. 5 shows a banknote transport path in first withdrawal processing.

FIG. 6 shows a banknote transport path in second withdrawal processing.

FIG. 7 shows a banknote transport path in reconciliation processing.

FIG. 8 is a flowchart related to a sheet handling method.

FIG. 9 shows, in closeup, an inlet, a transport mechanism, and a recognition unit.

FIG. 10 shows, in closeup, an inlet, a transport mechanism, and a recognition unit according to a modification.

FIG. 11 shows an outlet in closeup.

FIG. 12 shows a rotating shaft of the outlet.

FIG. 13 shows an outlet according to a modification.

FIG. 14 shows an outlet according to another modification.

### DETAILED DESCRIPTION OF THE DRAWINGS

The first transport unit, second transport unit, and third transport unit of the conventional banknote depositing and dispensing machine are laid out in a housing such that a transport path length is minimized.

When an attempt is made to increase the transport path length corresponding to a banknote length, the size of the housing needs to be increased.

The technique disclosed here relates to a sheet handling device. The sheet handling device includes
a receiving port that receives a sheet into a housing,
a transport mechanism that transports the sheet received into the housing through the receiving port and
a recognition circuit that has a first passing port and a second passing port through which the sheet transported by the transport mechanism passes and recognizes the sheet passing the first passing port and the second passing port.

The first passing port of the recognition circuit is positioned apart from the receiving port in a first direction,
the transport mechanism has a first path which is part of a transport path connecting the receiving port and the first passing port to each other, and
the first path is inclined, with respect to a first reference line extending in the first direction, apart from the first passing port while extending from the receiving port to the first passing port.

The sheet handling device includes the recognition circuit. The first passing port of the recognition circuit is positioned apart from the receiving port in the first direction. The transport mechanism transports a sheet between the receiving port and the recognition circuit. The transport mechanism has the transport path connecting the receiving port and the first passing port to each other. The first path of the transport path is inclined, with respect to the first reference line, apart from the first passing port while extending from the receiving port to the first passing port. The length of the first path is longer than a distance in the first direction between the receiving port and the first passing port. For the transport mechanism, the relatively-long transport path having a length corresponding to the length of a sheet can be ensured without increasing the size of the sheet handling device. For example, even when a sheet is stopped between the receiving port and the first passing port, the end of the sheet is apart from the receiving port and the first passing port.

The first direction may be the horizontal direction, and
the first path may be inclined upward.

The size of the sheet handling device in the horizontal direction is not increased.

The first passing port may be positioned lower than the receiving port.

The first passing port and the receiving port are apart from each other in the top-bottom direction, and therefore, the length of the transport path between the receiving port and the first passing port is longer.

The transport mechanism may have a second path extending continuously to the first path and extending in a second direction perpendicular to the first direction, and
the first passing port may be connected to the second path.

The second path extends in the second direction, and therefore, the length of the transport path between the receiving port and the first passing port is long.

The second path may be inclined, with respect to a second reference line extending in the second direction, apart from the receiving port while extending from the first passing port to the receiving port.

The second path is inclined, and therefore, the length of the second path is longer than a distance in the second direction between the receiving port and the first passing port. For the transport mechanism, the relatively-long transport path having a length corresponding to the length of a sheet can be ensured without increasing the size of the sheet handling device.

A connection portion between the first path and the second path may be apart in the first direction from the receiving port than the first passing port is from the receiving port.

The length of the transport path between the receiving port and the first passing port is longer than that in a case where the receiving port and the first passing port are connected to each other with the shortest distance.

The sheet handling device may further include a storage that is connected to the second passing port of the recognition circuit and stores a sheet,
the transport mechanism may have a first drive system that transports a sheet on the transport path connecting the receiving port and the first passing port to each other and a second drive system that is provided independently of the first drive system and transports a sheet between the recognition circuit and the storage.

The second drive system can transport a sheet fed out from the storage to the recognition circuit, and can cause the sheet to pass the recognition circuit.

The first drive system can transport a sheet having passed the recognition circuit toward the receiving port. Moreover, the first drive system can stop a sheet between the receiving port and the first passing port. Even when the first drive system stops sheet transport, the second drive system can be continuously driven. This is because the first drive system and the second drive system are independent of each other.

Further, the first drive system can transport a sheet stopped between the receiving port and the first passing port toward the first passing port. The second drive system can cause a sheet to pass the recognition circuit, and transport the sheet to the storage.

The storage may feed out a stored sheet in a case where an inventory amount is uncertain,
the second drive system may transport the sheet fed out from the storage to the second passing port, and the recognition circuit may recognize the sheet, and
the first drive system may stop the sheet having passed the first passing port in the middle of the transport path between the recognition circuit and the receiving port until the recognition circuit outputs a recognition result.

The second drive system is continuously driven while the first drive system stops a sheet in the middle of the transport path between the recognition circuit and the receiving port. The driven recognition circuit can output the recognition result.

The first drive system may transport the sheet to the first passing port after the recognition circuit has output the recognition result, and
the second drive system may transport the sheet having passed the second passing port to the storage.

A sheet whose recognition result has been output is transported to the original storage by the first drive system and the second drive system. Based on the sheet recognition result, the inventory amount of the storage is confirmed.

The sheet handling device may further include a second storage that is connected to the second passing port, stores a sheet, and does not feed out the stored sheet.

The storage may perform first feeding of the stored sheet in a case where the inventory amount is uncertain, and
the second drive system may transport the sheet related to the first feeding to the second storage after the recognition circuit has output a recognition result of the sheet related to the first feeding.

The storage may perform second feeding of the stored sheet after the sheet related to the first feeding has been stored in the second storage, and
the second drive system may transport the sheet related to the second feeding to the second storage after the recognition circuit has output a recognition result of the sheet related to the second feeding. Moreover, the sheet related to the second feeding may be transported to the storage.

The storage whose inventory amount is uncertain feeds out a sheet at least twice, i.e., performs the first feeding and the second feeding. The recognition circuit recognizes at least two sheets. The inventory amount of the storage can be more accurately confirmed.

A sheet other than a sheet finally fed out from the storage, such as the sheet related to the first feeding, is transported to the second storage after the output of the recognition result, and is stored in the second storage. The storage can feed out, in the second feeding, a sheet different from that related to the first feeding.

The sheet handling device may further include a reject unit that is connected to the second passing port and stores a reject sheet, and
the second drive system may transport, to the reject unit, a sheet indicated as a reject sheet by the recognition result and having passed the second passing port.

The sheet indicated as the reject sheet by the recognition result is not stored in the storage. The reject sheet is excluded from sheets to be dispensed from the sheet handling device.

The sheet handling device may further include a dispensing port that is connected to the second passing port and dispenses a sheet to the outside of the housing.

The storage may feed out the stored sheet in a case where the sheet is dispensed to the dispensing port,
the second drive system may transport the sheet fed out from the storage to the second passing port, and the recognition circuit may recognize the sheet, and
the first drive system may stop the sheet having passed the first passing port in the middle of the transport path between the recognition circuit and the receiving port until the recognition circuit outputs the recognition result.

Before a sheet is dispensed from the sheet handling device, the sheet is recognized. The accuracy of the sheet dispensed from the sheet handling device is enhanced.

As in the above-described configuration, the first drive system stops a sheet in the middle of the transport path between the recognition circuit and the receiving port. The second drive system continues the drive of the recognition circuit so that the recognition circuit can output the recognition result.

The first drive system may transport the sheet to the first passing port after the recognition circuit has output the recognition result, and
the second drive system may transport the sheet having passed through the second passing port to the dispensing port.

After the recognition result has been output, the first drive system and the second drive system transport a sheet to the dispensing port through the recognition circuit. The recognized sheet is dispensed to the outside of the sheet handling device through the dispensing port.

The sheet handling device may further include a second storage that is connected to the second passing port, stores a sheet, and does not feed out the stored sheet, and
the second drive system may transport a sheet indicated as being not able to be dispensed by the recognition result to the second storage after the sheet has passed the second passing port.

The sheet indicated as being not able to be dispensed by the recognition result is not dispensed from the sheet handling device.

In a case where a sheet which has been fed out and is to be dispensed to the dispensing port is a reject sheet, the sheet handling device may be shut down due to an error in a state in which the sheet is stopped in the middle of the transport path between the recognition circuit and the receiving port.

A person in charge takes out the sheet stopped in the middle of the transport path between the recognition circuit and the receiving port due to the error. The person in charge recovers the sheet handling device from the error-down state.

The second drive system may transport a sheet recognized by the recognition circuit to the dispensing port in a first mode, and
the second drive system may transport a sheet fed out from the storage to the dispensing port without transporting the sheet to the recognition circuit in a second mode.

The sheet handling device can recognize a sheet before the sheet is dispensed, and can also skip recognition.

Another sheet handling device disclosed here includes
a receiving port that receives a sheet into a housing,
a transport mechanism that transports the sheet received into the housing through the receiving port, and
a recognition circuit that has a first passing port and a second passing port through which the sheet transported by the transport mechanism passes and recognizes the sheet passing the first passing port and the second passing port.

The first passing port of the recognition circuit is positioned apart from the receiving port in a second direction,
the transport mechanism has a second path which is part of a transport path connecting the receiving port and the first passing port to each other, and
the second path is inclined, with respect to a second reference line extending in the second direction, apart from the receiving port while extending from the first passing port to the receiving port.

The second path of the transport path is inclined, with respect to the second reference line, apart from the receiving port while extending from the first passing port to the receiving port. The length of the second path is longer as compared to a distance in the second direction between the receiving port and the first passing port. For the transport mechanism, the transport path having a length corresponding to the length of a sheet can be ensured without increasing the size of the sheet handling device. For example, even when a sheet is stopped between the receiving port and the first passing port, the end of the sheet is apart from the receiving port and the first passing port.

A sheet handling method disclosed here includes
feeding out, by a storage that stores a sheet, the sheet from the storage,
transporting, by a transport mechanism, the sheet fed out from the storage to a recognition circuit,
recognizing the sheet by the recognition circuit,
stopping, by the transport mechanism, the sheet at a position after the sheet has passed the recognition circuit until the recognition circuit outputs a recognition result, and
transporting, by the transport mechanism, the sheet in a reverse direction such that the sheet passes the recognition circuit after the recognition circuit has output the recognition result.

A sheet fed out from the storage is recognized by passing the recognition circuit. The sheet is stopped at the position after the sheet has passed the recognition circuit, and while the sheet is stopped, the recognition circuit outputs the recognition result. After the recognition circuit has output the recognition result, the sheet is transported in the reverse direction by the transport mechanism. The recognized sheet passes the recognition circuit in the reverse direction.

The storage may feed out the stored sheet in a case where the inventory amount is uncertain.

The sheet fed out from the storage is recognized so that the inventory amount of the storage can be confirmed.

Information on the sheet stored in the storage may be stored, and
in a case where the recognition result does not match the stored information, the sheet stored in the storage may be newly fed out and recognized. The sheet recognized first may be transported, by the transport mechanism, to the second storage that does not feed out the sheet stored after having passed the recognition circuit.

A sheet for which at least any of a denomination and recognition information cannot be recognized is not stored in the storage again. In this case, the sheet may be transported to the dispensing port.

In a case where the recognition result matches the stored information, the sheet may be transported, by the transport mechanism, to the storage through the recognition circuit.

The sheet matching the stored information is stored in the original storage again.

In a case where the recognition result matches the stored information, the sheet may be transported, by the transport mechanism, to the second storage different from the storage through the recognition circuit.

The sheet matching the stored information is stored in the second storage, and therefore, is not dispensed.

The information on the sheet stored in the storage may be updated after the sheet has been stored in the storage or the second storage.

Based on the storage in which the sheet is stored after recognition, the information on the sheet stored in the storage is updated. That is, in a case where the storage in which the sheet is stored after recognition is the storage, information on the storage includes the information on the sheet. In a case where the storage in which the sheet is stored after recognition is the second storage, the information on the storage does not include the information on the sheet.

In a case where a sheet is dispensed through the dispensing port, the storage may feed out the stored sheet.

The recognized sheet is dispensed through the dispensing port.

The sheet indicated as being able to be dispensed by the recognition result may be transported to the dispensing port through the recognition circuit by the transport mechanism, and the device may be shut down due to an error in a state in which the sheet indicated as being not able to be dispensed by the recognition result is stopped at a position after the sheet has passed the recognition circuit.

In a case where a sheet to be dispensed is not able to be dispensed, the device is shut down due to an error so that the person in charge can take out the sheet. The sheet which is not able to be dispensed is properly handled.

Hereinafter, an embodiment of a sheet handling device will be described with reference to the drawings. The sheet handling device described here is an example.

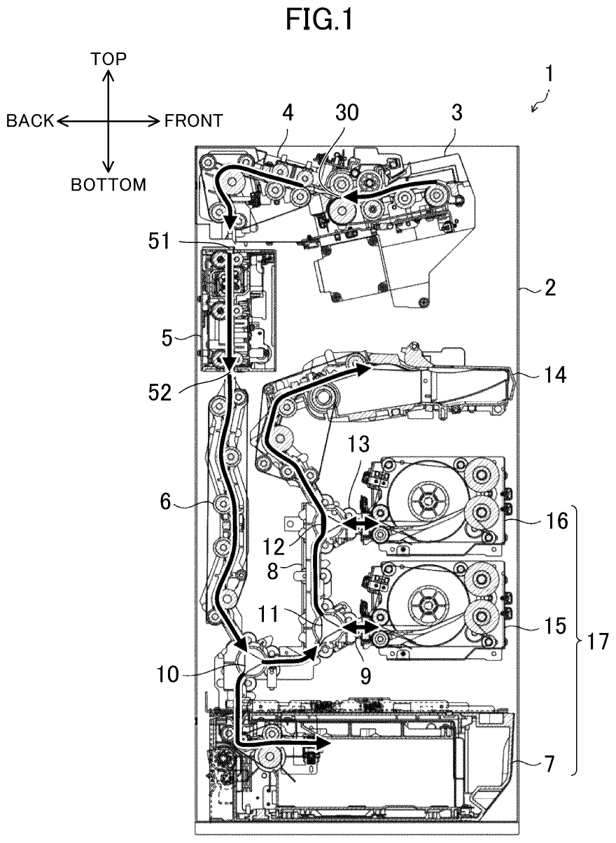

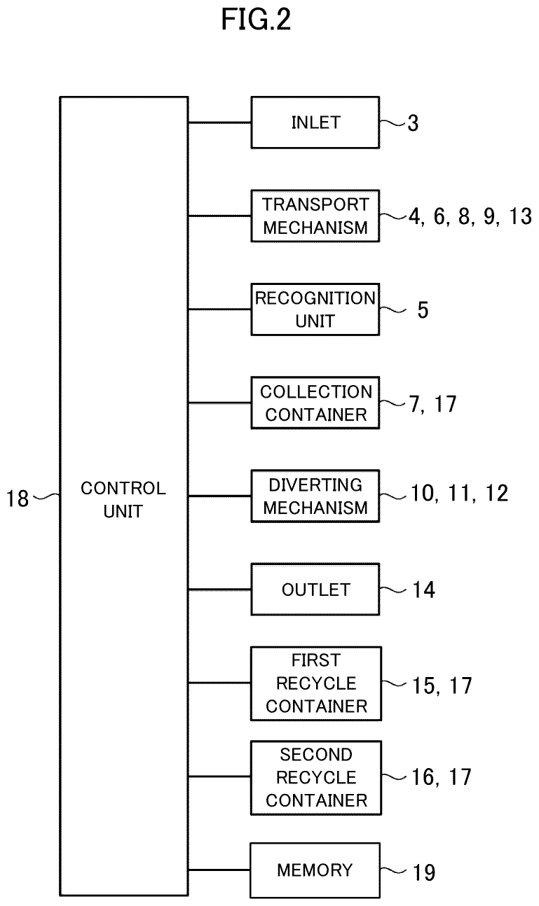

FIG. 1 shows an internal structure of a sheet handling device 1. FIG. 2 is a block diagram showing a functional configuration of the sheet handling device 1.

The sheet handling device 1 performs banknote depositing processing, banknote withdrawal processing, and banknote reconciliation processing. Hereinafter, a case where a sheet is a banknote will be described. Note that the sheet handling device 1 can perform the processing of depositing several types of banknotes, but two types (two denominations) of banknotes are set as a recycle banknote which can be withdrawn. A banknote of a denomination which is not set as a recycle banknote can be deposited, and when the banknote of the denomination which is not set as a recycle banknote is deposited, such a banknote is directly transported to a collection container.

The sheet handling device 1 includes a housing 2, an inlet 3, a transport mechanism 4, a recognition unit 5, a transport mechanism 6, a collection container 7, a transport mechanism 8, a transport mechanism 9, a diverting mechanism 10, a diverting mechanism 11, a diverting mechanism 12, a transport mechanism 13, an outlet 14, a first recycle container 15, a second recycle container 16, a control unit 18, and a memory 19. The collection container 7, the first recycle container 15, and the second recycle container 16 will be collectively referred to as a storage unit 17.

The housing 2 houses elements forming the sheet handling device 1, and has a substantially rectangular parallelepiped shape.

The inlet 3 is an element that receives a banknote. The inlet 3 is provided in an upper portion of the front surface (right upper portion in FIG. 1) of the housing 2. The front surface of the housing 2 is a surface in which the inlet 3 is provided, and a user of the sheet handling device 1 faces the front surface of the housing 2. The user inserts a banknote into the inlet 3. The inlet 3 has a mechanism that takes banknotes into the device one by one. The inlet 3 has a receiving port 30. The receiving port 30 receives a banknote into the housing 2.

The transport mechanism 4 transports a banknote put into the inlet 3 to the recognition unit 5. The transport mechanism 4 is provided at the substantially same height position as that of the inlet 3 in back of the inlet 3. The transport mechanism 4 substantially horizontally transports a banknote from the inlet 3, and thereafter, changes a transport direction in the vicinity of the back surface of the housing 2 and substantially vertically transports the banknote to the recognition unit 5 arranged below the transport mechanism 4.

The transport mechanism 4 includes a combination of many rollers, a plurality of belts, a motor that drives these rollers and belts, and a plurality of guides. Note that the structure of the transport mechanism 4 will be described in detail later.

The recognition unit 5 recognizes a banknote. The recognition unit 5 is one example of a recognition circuit. The recognition unit 5 is provided below the transport mechanism 4 in the back surface of the housing 2. The back surface of the housing 2 is a surface opposite to the front surface of the housing 2 in the horizontal direction.

The recognition unit 5 has a first passing port 51 and a second passing port 52. A banknote passes the recognition unit 5 through the first passing port 51 and the second passing port 52. The recognition unit 5 has at least any one of sensors such as an image sensor, an optical sensor, and a magnetic sensor, and acquires images of banknotes one by one to recognize, e.g., the authenticity and denomination thereof. Moreover, the recognition unit 5 acquires the serial number of a banknote. Further, the recognition unit 5 may recognize the fitness of a banknote.

The transport mechanism 6 transports a banknote transported from the recognition unit downward, specifically the collection container 7 or the transport mechanism 8. Note that banknote transport to the collection container 7 or the transport mechanism 8 is switched by the diverting mechanism 10 provided for the transport mechanism 6.

The transport mechanism 6 is provided below the recognition unit 5 and above the collection container 7 on the back surface side of the housing 2. The transport mechanism 6 includes a combination of a plurality of rollers, a plurality of belts, a motor that drives these rollers and belts, and a plurality of guides. Note that the transport mechanism 6 can also transport a banknote upward.

The collection container 7 collects a banknote which has been transported from the transport mechanism 6 by way of the recognition unit 5 and is not used for recycling. Here, the banknote which is not used for recycling is, for example, a banknote of a type which is not set to be stored in and fed out from the first recycle container 15 and the second recycle container 16 or a banknote which does not need to be stored more or cannot be stored more because a set number of banknotes has been already stored in the first recycle container 15 and the second recycle container 16. In a case where a damaged banknote is recognized, such a banknote may be transported to the collection container. The banknote of the type which is not set to be stored in and fed out from the first recycle container 15 and the second recycle container 16 includes, for example, a banknote of a high denomination which cannot be used as change. When a banknote fed out from the first recycle container 15 or the second recycle container 16 is collected in response to a collection instruction from the user via, e.g., an operation terminal, the collection container 7 is also used. The collection container 7 is one example of a second storage from which a stored sheet is not fed out.

The collection container 7 is provided at the lowermost portion in the housing 2. That is, the collection container 7 is arranged lower than all the transport mechanisms 4, 6, 8, 9, 13 so that the collection container 7 can extend across the entirety of the housing 2 in the front-back direction thereof.

The transport mechanism 8 connects the transport mechanism 6 and the outlet 14 to each other through the diverting mechanism 10. The transport mechanism 8 transports a banknote transported from the transport mechanism 6 upward, specifically to the transport mechanism 9 through the diverting mechanism 11. Moreover, the transport mechanism 8 transports a banknote transported from the transport mechanism 6 upward, specifically to the transport mechanism 13 through the diverting mechanism 11 and the diverting mechanism 12. Further, the transport mechanism 8 transports a banknote transported from the transport mechanism 6 upward, specifically to the outlet 14 through the diverting mechanism 11 and the diverting mechanism 12. In addition, the transport mechanism 8 transports a banknote transported from the transport mechanism 9 upward, specifically to the outlet 14 through the diverting mechanism 11 and the diverting mechanism 12. Moreover, the transport mechanism 8 transports a banknote transported from the transport mechanism 13 upward, specifically to the outlet 14 through the diverting mechanism 12.

The transport mechanism 8 is provided between the transport mechanism 6 and the first and second recycle containers 15, 16 in the front-back direction of the device. That is, the transport mechanism 8 is arranged on the front side of the housing 2 with respect to the transport mechanism 6. The transport mechanism 8 includes a combination of many rollers, a plurality of belts, a motor that drives these rollers and belts, and a plurality of guides. Note that the transport mechanism 8 can also transport a banknote downward, i.e., in the direction from the outlet 14 to the transport mechanism 6.

The transport mechanism 9 is a transport mechanism diverged through the diverting mechanism 11, and transports a banknote transported by the transport mechanism 8 to the first recycle container 15. The transport mechanism 9 diverged in the horizontal direction from the transport mechanism 8 through the diverting mechanism 11 is connected to the first recycle container 15, and a banknote is transported in the horizontal direction to the first recycle container 15. Moreover, the transport mechanism 9 transports a banknote transported from the first recycle container 15 to the transport mechanism 8 through the diverting mechanism 11. The transport mechanism 9 is provided between the diverting mechanism 11 and the first recycle container 15.

The transport mechanism 13 is a transport mechanism diverged through the diverting mechanism 12, and transports a banknote transported by the transport mechanism 8 to the second recycle container 16. The transport mechanism 13 diverged in the horizontal direction from the transport mechanism 8 through the diverting mechanism 12 is connected to the second recycle container 16, and a banknote is transported in the horizontal direction to the second recycle container 16. Moreover, the transport mechanism 13 transports a banknote transported from the second recycle container 16 to the transport mechanism 8 through the diverting mechanism 12. The transport mechanism 13 is provided between the diverting mechanism 12 and the second recycle container 16.

The diverting mechanism 10, 11, 12 is a three-way diverting mechanism that transports a banknote by switching the transport direction among three transport directions. Diversion by the diverting mechanism 10, 11, 12 is controlled by switching a diverting point according to detection of passage of a banknote by a sensor. The diverting point is switched using a recognition result obtained by the recognition unit 5 and detection of passage by a sensor provided in the transport mechanism 6 or using information stored in the later-described memory 19 and detection of passage by a sensor provided in the transport mechanism 9 or the transport mechanism 13. For example, the switching method includes a method in which the diverting point is switched when light from the sensor is blocked by the tip end of a banknote and a method in which the diverting point is switched to a next banknote transport destination when light from the sensor is no longer blocked after passage of the back end of a preceding banknote.

The outlet 14 is an element that dispenses a banknote to the outside of the device. The outlet 14 is provided below the inlet 3 in the upper portion of the front surface of the housing 2. The outlet 14 holds a plurality of banknotes in a stacked manner. The user takes out the banknotes from the outlet 14.

The first recycle container 15 stores a banknote transported from the transport mechanism 9. In a case where the withdrawal processing needs a banknote, the banknote is transported to the outlet 14 through the transport mechanism 9 and the transport mechanism 8. The first recycle container 15 is provided between the transport mechanism 9 and the front surface of the housing 2 in the front-back direction of the device and between the collection container 7 and the second recycle container 16 in the top-bottom direction of the device. The first recycle container 15 is a tape type storage that stores a banknote by winding the banknote around a drum together with a tape. The first recycle container 15 is a so-called last-in first-out storage. The first recycle container 15 has a full detection sensor, and the full detection sensor detects whether the storage is full of stored banknotes. The full detection sensor includes, for example, a photo interrupter.

The second recycle container 16 stores a banknote transported from the transport mechanism 13. In a case where the withdrawal processing needs a banknote, the banknote is transported to the outlet 14 through the transport mechanism 13 and the transport mechanism 8. The second recycle container 16 is provided between the transport mechanism 13 and the front surface of the housing 2 in the front-back direction of the device and between the first recycle container 15 and the outlet 14 in the top-bottom direction of the device. The second recycle container 16 is a tape type storage that stores a banknote by winding the banknote around a drum together with a tape. The second recycle container 16 is a so-called last-in first-out storage. The second recycle container 16 has a full detection sensor, and the full detection sensor detects whether the storage is full of stored banknotes. The full detection sensor includes, for example, a photo interrupter.

The first recycle container 15 and the second recycle container 16 are one example of a storage connected to the second passing port 52 of the recognition unit 5 such that a sheet is stored in and fed out from the storage. In the present embodiment, the type of banknote to be stored in the first recycle container 15 and the second recycle container 16 is set, and banknotes of a single set denomination are stored in each of the first recycle container 15 and the second recycle container 16.

Here, the recognition unit 5 and the first and second recycle containers 15, 16 are arranged at different height positions. Thus, the sheet handling device 1, i.e., the housing 2, can be reduced in size in the front-back direction.

The recognition unit 5 is arranged at the position higher than the storage unit 17. Thus, a distance from recognition to storage of a banknote can be increased, and the time for recognition can be ensured. In order to transport a banknote to a proper transport destination, the recognition result needs to be acquired until the banknote is diverted to the transport destination, specifically until the banknote reaches the diverting mechanism 10 in the present embodiment. In a case where a distance from the recognition unit to the diverting point is short, a banknote fails to be recognized, and cannot be properly diverted. Alternatively, the time until the recognition result is obtained needs to be adjusted in such a manner that banknote transport is stopped or a transport speed is decreased. The length of the transport mechanism corresponding to movement until the recognition result is obtained is ensured so that a banknote can be efficiently transported to a proper transport destination without stopping transport or decreasing the speed.

As shown in FIG. 2, the control unit 18 controls operation of the inlet 3, the transport mechanism 4, the recognition unit 5, the transport mechanism 6, the collection container 7, the transport mechanism 8, the transport mechanism 9, the diverting mechanism 10, the diverting mechanism 11, the diverting mechanism 12, the transport mechanism 13, the outlet 14, the first recycle container 15, the second recycle container 16, and the memory 19 described above. The control unit 18 is, for example, a CPU.

The memory 19 saves identification information on a banknote stored in the storage unit 17. The memory 19 stores, for example, identification information, a storage order, a denomination, a number, and a full state regarding a banknote stored in each of the collection container 7, the first recycle container 15, and the second recycle container 16. Note that the memory 19 is a memory of the sheet handling device 1, a memory of a separately-connected server, or a memory built in the storage unit 17. The memory 19 may include, for example, a plurality of memories for each of the collection container 7, the first recycle container 15, and the second recycle container 16. In each type of processing described later, the control unit 18 can acquire, from the information held in the memory 19, the number of banknotes stored in each recycle container, the denomination of a banknote stored in the top of each recycle container, a full detection state, etc.

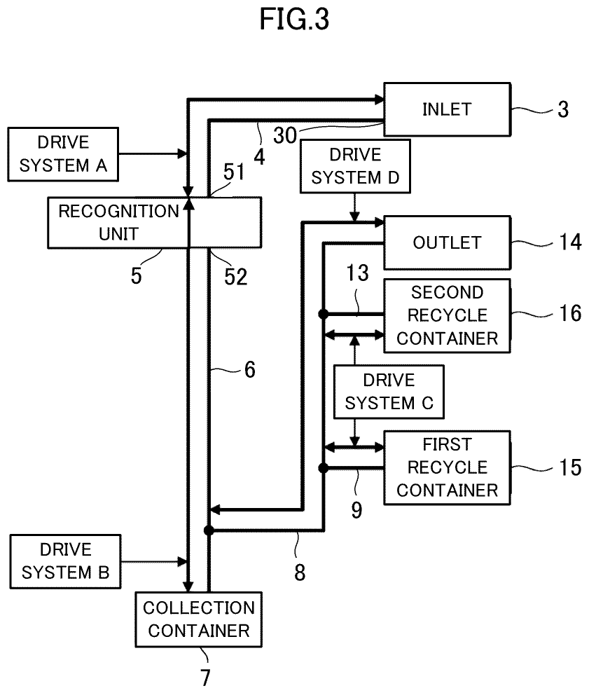

FIG. 3 is a diagram showing an example of divided drive systems of the sheet handling device 1. As shown in FIG. 3, the sheet handling device 1 has four drive systems A, B, C, D. The drive system A drives the transport mechanism 4. The drive system A is one example of a first drive system. The drive system B drives the recognition unit 5 and the transport mechanism 6. The drive system B may further drive a transport mechanism in the collection container 7. The drive system B is one example of a second drive system. The drive system C drives the transport mechanism 9 and the transport mechanism 13. The drive system D drives the transport mechanism 8.

FIG. 3 is one example, and the divided drive systems are not limited thereto. Some of the drive systems of FIG. 3 may be collectively driven, or on the other hand, may be further divided and driven.

The overview of the entirety of the sheet handling device 1 will be described. A banknote transport path from the inlet 3 to the outlet 14 is in a U-shape. The recognition unit 5 is provided on the inlet 3 side, and the first recycle container 15 and the second recycle container 16 as the storages forming the storage unit 17 are provided on the outlet 14 side. The transport path does not have a circulating structure.

Next, a method for handling a banknote using the sheet handling device 1 will be described with reference to the figures.

### (Depositing Processing)

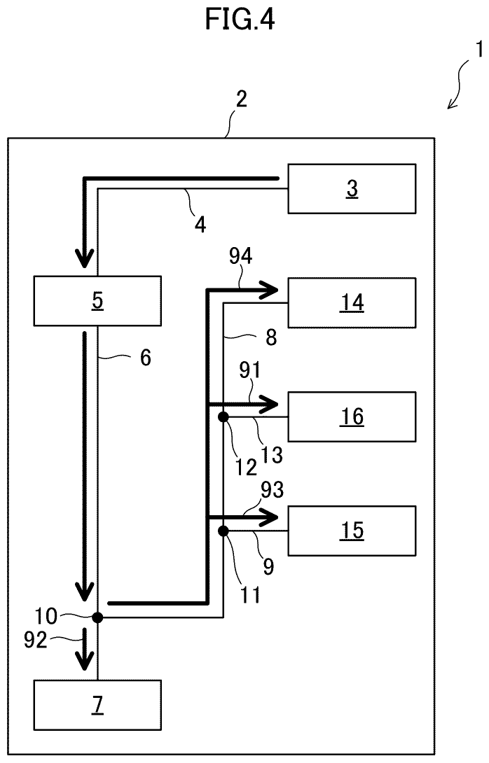

First, a method for performing the banknote depositing processing will be described with reference to FIG. 4. FIG. 4 shows the banknote transport path in the depositing processing. Note that in this depositing processing, a five-dollar banknote is stored in the first recycle container and a one-dollar banknote is stored in the second recycle container 16 as a deposited banknote.

First, a banknote is injected into the inlet 3, and thereafter, is transported to the recognition unit 5 by the transport mechanism 4.

Next, the recognition unit 5 recognizes the type of banknote. Based on the recognition result obtained by the recognition unit 5, the control unit 18 controls each element such that the one-dollar banknote is transported to the second recycle container 16. After recognition, the one-dollar banknote is transported to the second recycle container 16 by way of the transport mechanism 6, the diverting mechanism 10, the transport mechanism 8, the diverting mechanism 11, the diverting mechanism 12, and the transport mechanism 13, and is stored in the second recycle container 16. Then, the depositing processing ends (see an arrow 91 in FIG. 4).

In a case where one-dollar banknotes stored in the second recycle container 16 are not the set number of banknotes or less (i.e., the second recycle container 16 is full), the control unit 18 controls each element such that the deposited one-dollar banknote is transported to the collection container 7. After recognition, the one-dollar banknote is transported to the collection container 7 by way of the transport mechanism 6 and the diverting mechanism 10, and is stored in the collection container 7. Then, the depositing processing ends (see an arrow 92 in FIG. 4). Determination on whether the second recycle container 16 is full may be made by detection by the full detection sensor or determination on whether the number of stored banknotes is greater than a predetermined number of banknotes. Determination may be made by both these determination criteria or only by one of these determination criteria.

Based on the recognition result obtained by the recognition unit 5, the control unit 18 controls each element such that the five-dollar banknote is transported to the first recycle container 15. After recognition, the five-dollar banknote is transported to the first recycle container 15 by way of the transport mechanism 6, the diverting mechanism 10, the transport mechanism 8, the diverting mechanism 11, and the transport mechanism 9, and is stored in the first recycle container 15. Then, the depositing processing ends (see an arrow 93 in FIG. 4).

In a case where five-dollar banknotes stored in the first recycle container 15 are not the set number of banknotes or less (i.e., the first recycle container 15 is full), the control unit 18 controls each element such that the banknote is transported to the collection container 7. The five-dollar banknote is transported to the collection container 7 by way of the transport mechanism 6 and the diverting mechanism 10, and is stored in the collection container 7. Then, the depositing processing ends (see the arrow 92 in FIG. 4). Determination on whether the first recycle container 15 is full may be made by detection by the full detection sensor or determination on whether the number of stored banknotes is greater than a predetermined number of banknotes. Determination may be made by both these determination criteria or only by one of these determination criteria.

In a case where the banknote is a banknote of another denomination which is neither the one-dollar banknote nor the five-dollar banknote, the control unit 18 controls each element such that the banknote is transported to the collection container 7. After recognition, the banknote is transported to the collection container 7 by way of the transport mechanism 6 and the diverting mechanism 10, and is stored in the collection container 7. Then, the depositing processing ends (see the arrow 92 in FIG. 4).

Note that in a case where it is determined based on the recognition result obtained by the recognition unit 5 that the banknote is a counterfeit note or is suspected to be a counterfeit note, the banknote may be transported to the outlet 14 and be dispensed to the outside of the device (see an arrow 94 in FIG. 4). Alternatively, a reject container may be arranged, and the banknote may be transported to and stored in the reject container. In a case where the fitness of the banknote can be determined, an unfit note may be similarly dispensed to the outside of the device or be stored in the reject container.

### (First Withdrawal Processing)

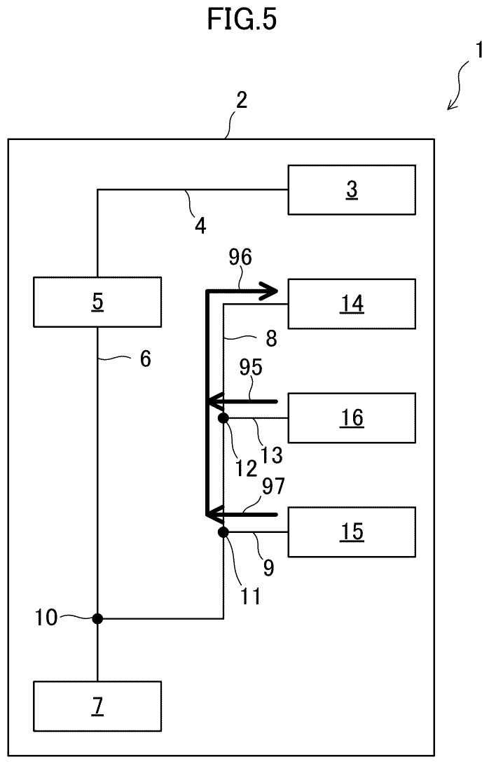

Next, a method for performing first banknote withdrawal processing will be described with reference to FIG. 5. FIG. 5 shows the banknote transport path in the first withdrawal processing. Note that in this withdrawal processing, a five-dollar banknote is stored in the first recycle container 15 and a one-dollar banknote is stored in the second recycle container 16.

In a case where the control unit 18 receives an instruction for withdrawing the one-dollar banknote, the control unit 18 controls each element such that the one-dollar banknote is transported from the second recycle container 16 to the outlet 14. The one-dollar banknote is transported to the outlet 14 by way of the transport mechanism 13, the diverting mechanism 12, and the transport mechanism 8, and is withdrawn (see arrows 95, 96 in FIG. 5). Such operation is repeated until a required number of banknotes is withdrawn based on the withdrawal instruction.

In a case where the control unit 18 receives an instruction for withdrawing the five-dollar banknote, the control unit 18 controls each element such that the five-dollar banknote is transported from the first recycle container 15 to the outlet 14. The five-dollar banknote is transported to the outlet 14 by way of the transport mechanism 9, the diverting mechanism 11, the transport mechanism 8, and the diverting mechanism 12, and is withdrawn (see the arrows 97, 96 in FIG. 5). Such operation is repeated until a required number of banknotes is withdrawn based on the withdrawal instruction.

### (Second Withdrawal Processing)

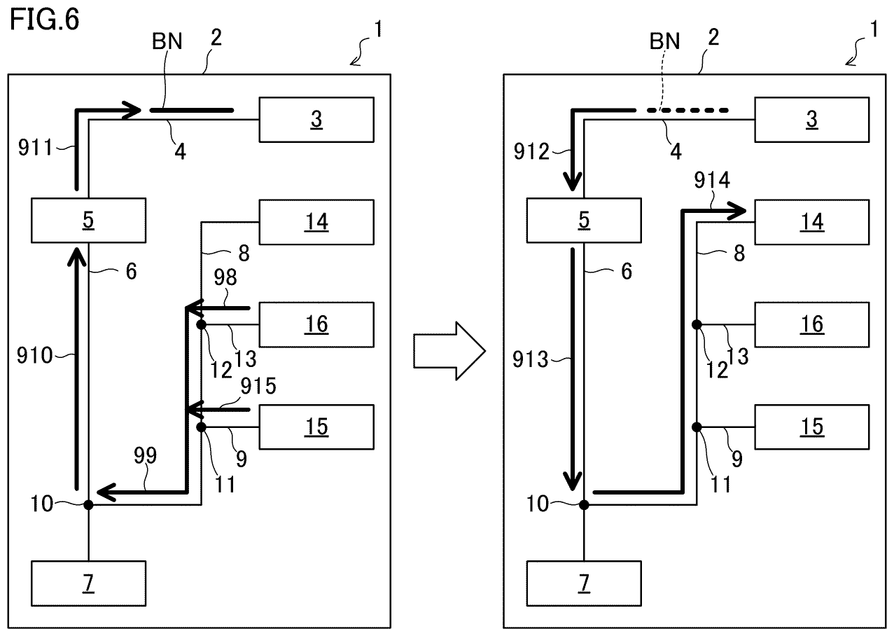

Next, a method for performing second banknote withdrawal processing will be described with reference to FIG. 6. FIG. 6 shows the banknote transport path in the second withdrawal processing. Note that in this withdrawal processing, a five-dollar banknote is stored in the first recycle container 15 and a one-dollar banknote is stored in the second recycle container 16.

The first withdrawal processing is the processing of transporting a banknote to the outlet 14 without recognizing the banknote. The second withdrawal processing is the processing of transporting a banknote to the outlet 14 after the banknote has been recognized.

In a case where the control unit 18 receives an instruction for withdrawing the one-dollar banknote, the control unit 18 controls each element such that the one-dollar banknote is transported from the second recycle container 16 to the recognition unit 5. The one-dollar banknote is transported to the recognition unit 5 by way of the transport mechanism 13, the diverting mechanism 12, the transport mechanism 8, the diverting mechanism 11, the diverting mechanism 10, and the transport mechanism 6 (see arrows 98, 99, 910 in FIG. 6). The recognition unit 5 recognizes the transported banknote.

The recognition unit 5 outputs the recognition result to the control unit 18 according to a clock signal generated by drive thereof. In order for the control unit 18 to obtain the recognition result obtained by the recognition unit 5, the recognition unit 5 needs to be continuously driven. In the present embodiment, as shown in FIG. 3, the drive system B for the transport mechanism 6 and the recognition unit 5 and the drive system A for the transport mechanism 4 are different from each other. As indicated by an arrow 911 on the left side in FIG. 6, when a banknote BN is transported to the transport mechanism 4 through the recognition unit 5, the drive system A stops driving. The banknote BN is stopped in the middle of the transport mechanism 4 between the recognition unit 5 and the inlet 3. Meanwhile, the drive system B for the transport mechanism 6 and the recognition unit 5 is continuously driven, and the control unit 18 obtains the recognition result.

When the control unit 18 obtains the recognition result, the drive system A for the transport mechanism 4 transports the banknote in the reverse direction as indicated by an arrow 912 on the right side in FIG. 6. The banknote is transported toward the first passing port 51 of the recognition unit 5, and passes through the recognition unit 5. After having passed the recognition unit 5, the banknote is transported to the outlet 14 by way of the transport mechanism 6, the diverting mechanism 10, the transport mechanism 8, the diverting mechanism 11, and the diverting mechanism 12, and is withdrawn (see arrows 913, 914 on the right side in FIG. 6). Note that such operation is repeated until a required number of banknotes is withdrawn based on the withdrawal instruction.

In a case where the control unit 18 receives an instruction for withdrawing the five-dollar banknote, the control unit 18 controls each element such that the five-dollar banknote is transported from the first recycle container 15 to the recognition unit 5. After having passed the recognition unit 5, the five-dollar banknote is stopped in the middle of the transport mechanism 4 between the recognition unit 5 and the inlet 3 (see the arrows 915, 99, 910, 911 on the left side in FIG. 6). The drive system B for the transport mechanism 6 and the recognition unit 5 is continuously driven, and the control unit 18 obtains the recognition result.

When the control unit 18 obtains the recognition result, the drive system A for the transport mechanism 4 transports the banknote in the reverse direction as indicated by the arrow 912 on the right side in FIG. 6. After having passed the recognition unit 5, the banknote is transported to the outlet 14 by way of the transport mechanism 6, the diverting mechanism 10, the transport mechanism 8, the diverting mechanism 11, and the diverting mechanism 12, and is withdrawn (see the arrows 913, 914 on the right side in FIG. 6). Note that such operation is repeated until a required number of banknotes is withdrawn based on the withdrawal instruction.

Note that in a case where the recognition result shows that the banknote cannot be withdrawn, the banknote may be transported to and stored in the collection container 7. For example, a banknote of a different denomination is recognized as not being able to be withdrawn. Moreover, for example, in a case where the serial number included in the identification information is different from the serial number recognized and stored in depositing, such a banknote may be recognized as not being able to be withdrawn, and be transported to the collection container 7.

In a case where the recognition unit 5 recognizes the banknote as a reject banknote, the control unit 18 shuts down the sheet handling device 1 due to an error in a state in which the banknote BN is stopped in the middle of the transport mechanism 4 between the recognition unit and the inlet 3. A person in charge takes out the banknote stopped in the middle of the transport mechanism 4 from the sheet handling device 1, and thereafter, recovers the sheet handling device 1 from the error-down state. With such operation, the reject banknote is properly handled.

Note that in some cases, the recognition unit 5 recognizes the banknote as a reject banknote due to failure in banknote transport. The failure in banknote transport may be resolved when the banknote is housed again in the first recycle container 15 or the second recycle container 16 and fed out again from the first recycle container 15 or the second recycle container 16. In a case where the recognition unit 5 recognizes the banknote as the reject banknote, the control unit 18 does not promptly shut down the sheet handling device 1 due to an error, but may execute the processing of storing the reject banknote in the first recycle container 15 or the second recycle container 16 again and feeding out such a banknote from the first recycle container 15 or the second recycle container 16 again such that the recognition unit 5 recognizes the banknote multiple times. Alternatively, a reject container may be arranged, and the reject banknote may be transported to and stored in the reject container.

The sheet handling device 1 has, as the withdrawal processing, the first withdrawal processing (i.e., corresponding to a second mode) and the second withdrawal processing (i.e., corresponding to a first mode). For example, in the case of withdrawal for change, the sheet handling device 1 may execute the first withdrawal processing. For the withdrawal for change, accuracy is allowed to be relatively low. The first withdrawal processing has an advantage that the time required for the processing is short. For example, in the case of withdrawal for refilling an automatic teller machine (ATM) or a self-machine with banknotes, the sheet handling device 1 may execute the second withdrawal processing. The second withdrawal processing has a longer time required for the processing, but has a higher accuracy in withdrawal.

In a case where the first recycle container 15 or the second recycle container 16 is a recycle container with no reconciliation flag described later, the sheet handling device 1 may execute the first withdrawal processing in normal withdrawal, and execute the second withdrawal processing to strictly perform the processing when a banknote is withdrawn from the recycle container with reconciliation flag.

In a case where the first recycle container 15 or the second recycle container 16 stores banknotes of plural denominations, the sheet handling device 1 may execute the first withdrawal processing when a banknote is withdrawn from the recycle container storing banknotes of a single denomination, and execute the second withdrawal processing when a banknote is withdrawn from the recycle container storing the banknotes of the plural denominations.

Note that in the collection processing of collecting a banknote stored in the sheet handling device 1 from the sheet handling device 1, the sheet handling device 1 can also execute processing similar to the first withdrawal processing and the second withdrawal processing as described above.

### (Reconciliation Processing)

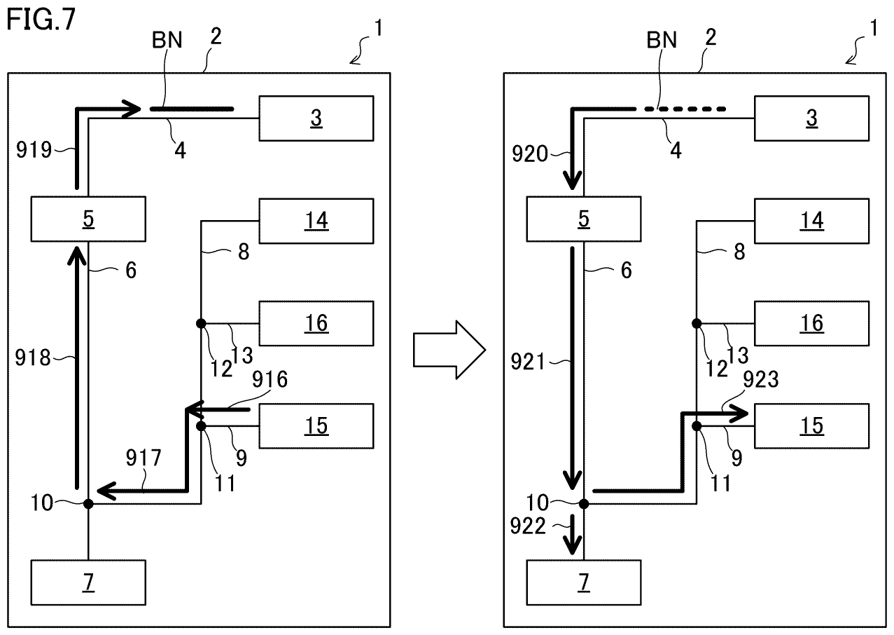

Next, the reconciliation processing will be described with reference to FIG. 7. FIG. 7 shows the banknote transport path in the reconciliation processing. For example, in a case where an error which may influence the inventory amount of the recycle container 15, 16, such as jam in the vicinity of the recycle container 15, 16, jam in the middle of depositing, or jam in the middle of withdrawal, is caused, the control unit 18 sets the reconciliation flag indicating that data on the target recycle container 15, 16 needs to be reconciled (i.e., the inventory amount is uncertain).

In a case where the reconciliation flag is set, the control unit 18 controls each element to perform the reconciliation processing on the target recycle container 15, 16. Specifically, in the reconciliation processing, the recognition unit 5 recognizes a banknote fed out from the recycle container 15, 16, and the inventory amount of the recycle container 15, 16 is checked by matching the recognition result against the banknote information stored in the memory 19. In the reconciliation processing, at least one banknote is fed out from the recycle container 15, 16. Here, it is assumed that two banknotes are fed out from the recycle container 15, 16. Note that one banknote or three or more banknotes may be fed out from the recycle container 15, 16 in the reconciliation processing.

A case where the reconciliation flag is set to the first recycle container 15 will be described hereinafter as an example. In description below, a banknote fed out first from the first recycle container 15 will be referred to as a first banknote, and a banknote fed out next will be referred to as a second banknote.

In a case where the reconciliation flag is set to the first recycle container 15, the first recycle container 15 feeds out the first banknote (see an arrow 916 on the left side in FIG. 7), and the transport mechanism 9, the diverting mechanism 11, the transport mechanism 6, etc. transport the first banknote to the recognition unit 5 (see arrows 917, 918 on the left side in FIG. 7). The recognition unit 5 recognizes the transported first banknote. The control unit 18 matches the information stored in the memory 19 against the information on the recognized banknote.

As described above, in order to obtain the recognition result from the recognition unit 5, the recognition unit 5 needs to be continuously driven. As indicated by an arrow 919 on the left side in FIG. 7, when the banknote BN is transported to the transport mechanism 4 through the recognition unit 5, the drive system A stops driving. The banknote BN is stopped in the middle of the transport mechanism 4 between the recognition unit 5 and the inlet 3. Meanwhile, the drive system B for the transport mechanism 6 and the recognition unit 5 is continuously driven, and the control unit 18 obtains the recognition result.

After completion of matching of the first banknote based on the recognition result, the drive of the transport mechanism 4 is reversely resumed, and the drive of the transport mechanism 6 is reversed. The recognized first banknote is transported to the collection container 7 (see arrows 920, 921, 922 on the right side in FIG. 7). This is for feeding out the second banknote from the first recycle container 15.

After the first banknote has been stored in the collection container 7, the first recycle container 15 feeds out the second banknote and the transport mechanism 9, the diverting mechanism 11, the transport mechanism 6, etc. transport the second banknote to the recognition unit 5, as indicated by the arrows 916, 917, 918, 919 on the left side in FIG. 7. The recognition unit 5 recognizes the transported second banknote. The control unit 18 matches the information stored in the memory 19 against the information on the recognized banknote.

After completion of matching of the second banknote based on the recognition result, the drive of the transport mechanism 4 is reversely resumed, and the drive of the transport mechanism 6 is reversed. The recognized second banknote is transported to the collection container 7 (see the arrows 920, 921, 922 on the right side in FIG. 7). Note that the recognized second banknote may be transported to the first recycle container 15 (see the arrows 920, 921, 923 on the right side in FIG. 7).

In a case where the recognition results of the consecutive first and second banknotes match the stored identification information, the first and second banknotes are stored in the collection container 7 or the first recycle container 15, and thereafter, the control unit 18 accepts the inventory amount of the first recycle container 15 based on the first and second banknote matching results. The inventory amount of the first recycle container 15 stored in the memory 19 is updated. At this time, the inventory amount of the first recycle container 15 changes according to the storage in which the first and second banknotes are stored. After completion of the reconciliation processing, the control unit 18 removes the reconciliation flag. In a case where the recognition results of the consecutive first and second banknotes do not match the stored identification information, the processing of feeding out a banknote from the first recycle container 15, recognizing the banknote, and storing the banknote according to the recognition result is repeated until the recognition results of two consecutive banknotes match the stored identification information. Note that regardless of the result of matching against the stored identification information, the recognized first banknote is stored in the collection container 7 in a case where the recognition unit 5 can recognize any of the denomination and the identification information. In a similar case, the recognized second banknote is stored in the collection container 7 or the first recycle container 15.

Note that in a case where the recognition unit 5 recognizes the banknote as a reject banknote, the reject banknote may be transported to the outlet 14. The outlet 14 is one example of a reject unit. The person in charge takes out the reject banknote from the outlet 14. For example, in a case where the information on the denomination of the banknote cannot be read, the banknote is transported as the reject banknote to the outlet. The reject banknote may be transported to the collection container 7. Alternatively, another storage unit such as a reject container may be provided, and the reject banknote may be transported to the reject container.

In a case where the reconciliation flag is set to the second recycle container 16, the reconciliation processing can also be executed in a similar method.

The sheet handling device 1 has the transport path connecting the inlet 3 and the outlet 14 to each other. When the recognition unit 5 recognizes a banknote fed out from the first recycle container 15 or the second recycle container 16 in the second withdrawal processing or the reconciliation processing, the transport mechanisms 4, 6, 8, 9, 13 need to transport the banknote toward the inlet 3. The transport mechanisms 4, 6, 8, 9, 13 reverse the direction of transport of the banknote recognized by the recognition unit 5 so that the banknote can be transported to the recycle container 15, 16, the collection container 7, or the outlet 14. In the sheet handling device 1 having no circulating transport path, the second withdrawal processing or the reconciliation processing in combination with recognition is implemented.

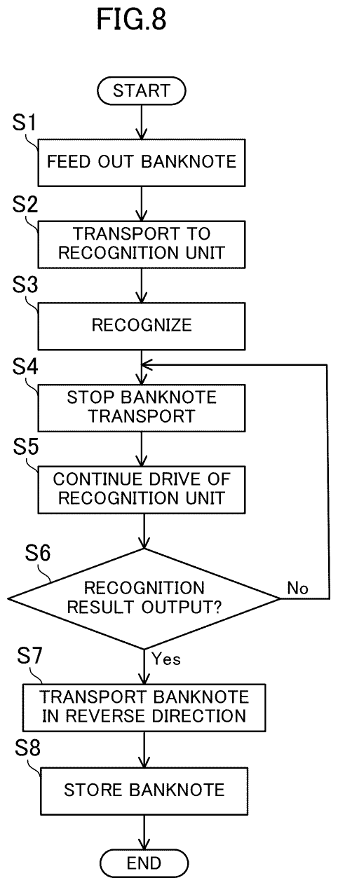

FIG. 8 is a flowchart related to the banknote handling method common between the second withdrawal processing and the reconciliation processing as described above. First, in Step S1 after the start, the first recycle container 15 or the second recycle container 16 feeds out a banknote.

Subsequently, in Step S2, the transport mechanisms 6, 8, 9, 13 transport the banknote to the recognition unit 5. In Step S3, the recognition unit 5 recognizes the banknote.

In Step S4, the transport mechanism 4 stops transport of the banknote having passed the recognition unit 5. In Step S5, the recognition unit 5 is continuously driven. In Step S6, the control unit 18 determines whether the recognition unit 5 has output the recognition result. In the case of No as the answer in determination in Step S6, the stop of banknote transport and the drive of the recognition unit are continued in Steps S4, S5. After the recognition unit 5 has output the recognition result, the transport mechanism 4 transports the banknote in the reverse direction in Step S7. The banknote passes the recognition unit 5. Thereafter, in Step S8, the banknote is stored in a predetermined storage.

(Structure of Transport Mechanism between Inlet and Recognition Unit)

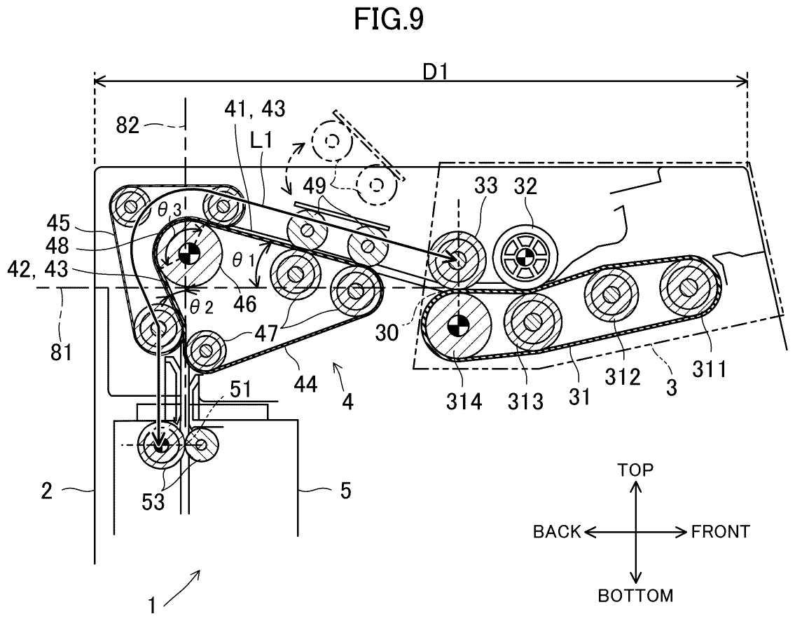

FIG. 9 shows, in closeup, the structure of the transport mechanism 4 between the inlet 3 and the recognition unit 5. As described above, in the second withdrawal processing or the reconciliation processing, a banknote fed out from the first recycle container 15 or the second recycle container 16 passes the recognition unit 5, and thereafter, is stopped in the transport mechanism 4 between the inlet 3 and the recognition unit 5. If the length L1 of the transport path between the inlet 3 and the recognition unit 5 is shorter than the maximum length (note that the maximum length is a length in the transport direction) of the banknote, the end of the banknote projects to the outside of the housing 2 through the inlet 3. The length L1 of the transport length is preferably longer than the maximum length of the banknote. Note that in a case where there is a time lag until the drive of the transport mechanism 4 is actually stopped after the stop instruction from the control unit 18, the length L1 of the transport path may be a length obtained by addition of a distance at which the banknote moves during the time lag until the transport mechanism 4 stops. That is, the length L1 of the transport path is set to such a distance that in the second withdrawal processing or the reconciliation processing, the banknote fed out from the first recycle container 15 or the second recycle container 16 does not project to the outside of the housing 2 through the inlet 3 when the drive of the transport mechanism 4 is stopped after the banknote has passed the recognition unit 5.

As the length of the transport path increases, the size of the sheet handling device increases. The sheet handling device 1 disclosed here ensures the long transport path between the inlet 3 and the recognition unit 5 without a size increase. Note that in description below, the front, the back, the top, and the bottom will be defined with reference to the housing 2. That is, the front is the front of the housing 2, and corresponds to the right on the plane of paper of FIG. 9. The back is the back of the housing 2, and corresponds to the left on the plane of paper of FIG. 9. The top is the top of the housing 2, and corresponds to the upper side on the plane of paper of FIG. 9. The bottom is the bottom of the housing 2, and corresponds to the lower side on the plane of paper of FIG. 9.

The inlet 3 has a feeding belt 31. The feeding belt 31 extends in the front-back direction. The feeding belt 31 is wound around a plurality of pulleys 311, 312, 313, 314 arranged in the front-back direction. Of the plurality of pulleys 311, 312, 313, 314, the pulley 314 positioned backmost is a drive pulley, and the pulleys 311, 312, 313 are driven pulleys. The feeding belt 31 positioned higher than the pulleys 311, 312, 313, 314 contacts the lower surface of a banknote held in the inlet 3. When the pulley 314 rotates counterclockwise as viewed in FIG. 9, the feeding belt 31 positioned thereon runs from the front to the back. The feeding belt 31 feeds a banknote positioned lowermost among a plurality of banknotes overlapping with each other in the inlet 3 into the housing 2.

The inlet 3 has a separation roller 32. The separation roller 32 faces the pulley 313. The separation roller 32 is a drive roller that rotates counterclockwise as viewed in FIG. 9. The separation roller 32 contacts a banknote positioned uppermost among the plurality of banknotes overlapping with each other in the inlet 3. The separation roller 32 rotates in the direction opposite to the banknote feeding direction, thereby separating the banknotes to be feed out by the feeding belt 31 one by one.

The inlet 3 has a pinch roller 33. The pinch roller 33 faces the pulley 314. The pinch roller 33 feeds a banknote into the housing 2 with the banknote sandwiched between the pinch roller 33 and the feeding belt 31.

Here, a back end portion of the inlet 3, in other words, an end portion of the inlet 3 connected to a first end of a transport path 43 described later, is defined as a position at which the pinch roller 33 and the pulley 314 face each other. This is because an area where the force of transport by the feeding belt 31 acts on a banknote in the inlet 3 is an area up to the position at which the pinch roller 33 and the pulley 314 face each other. The back end portion of the inlet 3 is the receiving port 30 that receives a sheet into the housing 2. Note that the receiving port 30 is not limited thereto.

The recognition unit 5 has a roller pair 53 including a drive roller. The roller pair 53 transports a banknote in the recognition unit 5. Here, an upper end portion of the recognition unit 5, in other words, an end portion of the recognition unit 5 connected to a second end of the transport path 43, is defined as the position of the roller pair 53. This is because an area where the force of transport by the roller pair 53 acts on a banknote in the recognition unit 5 is an area up to the position of the roller pair 53. That is, the position of the roller pair 53 is the first passing port 51 of the recognition unit 5. Note that the first passing port 51 is not limited thereto.

The first passing port 51 of the recognition unit 5 is positioned, in back of the receiving port 30 of the inlet 3, apart in the horizontal direction from the receiving port 30, and is positioned, lower than the receiving port 30, apart from the receiving port 30 in the top-bottom direction. Note that a chain line 81 in FIG. 9 is a first reference line 81 extending in the horizontal direction from the receiving port 30 and a chain line 82 is a second reference line 82 extending in the top-bottom direction from the first passing port 51.

The transport mechanism 4 has the transport path 43. The transport path 43 connects the receiving port 30 of the inlet 3 and the first passing port 51 of the recognition unit 5 to each other. The transport path 43 includes a first path 41 and a second path 42. The first path 41 is connected to the receiving port 30 of the inlet 3. The second path 42 is continuous to the first path 41, and is connected to the first passing port 51 of the recognition unit 5. As indicated by a thick solid arrow in FIG. 9, the area of the transport path 43 is an area where a banknote can be transported by the drive force of a later-described large pulley 46.

The first path 41 extends substantially in the horizontal direction from the receiving port of the inlet 3. More specifically, the first path 41 is more inclined upward with respect to the horizontal first reference line 81 with an increase in a distance from the receiving port 30 in the backward direction. In other words, the first path 41 is inclined, with respect to the first reference line 81, apart from the first passing port 51 while extending from the receiving port 30 to the first passing port 51. The inclination angle of the first path 41 is θ1.

The second path 42 extends substantially in the top-bottom direction. More specifically, the second path 42 includes a portion more inclined backward with respect to the vertical second reference line 82 with an increase in a distance from the first passing port 51 of the recognition unit 5 in the upward direction. In other words, the second path 42 is inclined, with respect to the second reference line 82, apart from the receiving port 30 while extending from the first passing port 51 to the receiving port 30. The inclination angle of the second path 42 is θ2.

The transport mechanism 4 has a drive belt 44 and a driven belt 45. The driven belt 45 overlaps with the drive belt 44. When the drive belt 44 runs, the driven belt 45 also runs.

The drive belt 44 is wound around the large pulley 46 and a plurality of small pulleys 47. The drive belt 44 is substantially in a triangular shape in a side view. The large pulley 46 is at the position of a connection portion 48 between the first path 41 and the second path 42. The large pulley 46 corresponds to a corner of the triangle of the drive belt 44, and the first path 41 and the second path 42 each correspond to sides of the triangle of the drive belt 44.

The large pulley 46 is a drive pulley. The large pulley 46 has a diameter greater than that of the small pulley 47. The large pulley 46 is positioned higher than the first reference line 81. The second reference line 82 overlaps with the large pulley 46. Part of the large pulley 46 is positioned in back of the second reference line 82, and therefore, the connection portion 48 between the first path 41 and the second path 42 is more apart in the horizontal direction from the receiving port 30 than the first passing port 51 is from the receiving port 30. Moreover, the large pulley 46 is positioned higher than the first reference line 81, and therefore, the connection portion 48 between the first path 41 and the second path 42 is more apart in the top-bottom direction from the first passing port 51 than the receiving port 30 is from the first passing port 51.

Each of the first path 41 and the second path 42 is inclined, and therefore, the drive belt 44 is wound around the large pulley 46 at an angle of θ3 of 90° or more.

The small pulleys 47 are all driven pulleys. The transport mechanism 4 has auxiliary rollers 49 on the first path 41. The two auxiliary rollers 49 are arranged along the inclined first path 41, and each face the small pulleys 47.

The first path 41 of the transport mechanism 4 is inclined. Moreover, the second path 42 is also inclined. Here, a case where the first path extends horizontally and the second path extends vertically will be assumed. The horizontal first path and the vertical second path connect the inlet 3 and the recognition unit 5 with the shortest distance. On the other hand, the length L1 of the transport path 43 is longer than the shortest transport path. The length L1 of the transport path 43 is longer than the maximum length of a banknote to be handled by the sheet handling device 1. In the second withdrawal processing or the reconciliation processing as described above, a banknote can be stopped in the transport mechanism 4 between the inlet 3 and the recognition unit 5. The end of the banknote stopped in the transport mechanism 4 is apart from the receiving port 30 and the first passing port 51.

While outputting the recognition result, the recognition unit 5 needs to be continuously driven. No drive force of the roller pair 53 of the recognition unit 5 acts on the banknote stopped in the transport mechanism 4 between the inlet 3 and the recognition unit 5, and therefore, the recognition unit 5 can be continuously driven to output the recognition result.

The sheet handling device 1 ensures the long transport path 43 in the housing 2, and the housing 2 is not increased in size. The length D1 of the housing 2 in the front-back direction is relatively short. Note that the greater diameter of the large pulley 46 also contributes to an increase in the length of the transport path 43 without increasing the length D1 of the housing 2 in the front-back direction.

As described above, in a case where the sheet handling device 1 is shut down due to an error in a state in which a banknote is stopped in the transport mechanism 4 between the inlet 3 and the recognition unit 5, the person in charge easily takes out the banknote because the length of the first path 41 is long. This is because the long first path 41 can be opened wide substantially in the horizontal direction by lifting of the auxiliary rollers 49, as indicated by a chain double-dashed line in FIG. 9.

Note that the second path 42 may extend in the top-bottom direction without inclination.

### (Modification of Transport Mechanism)

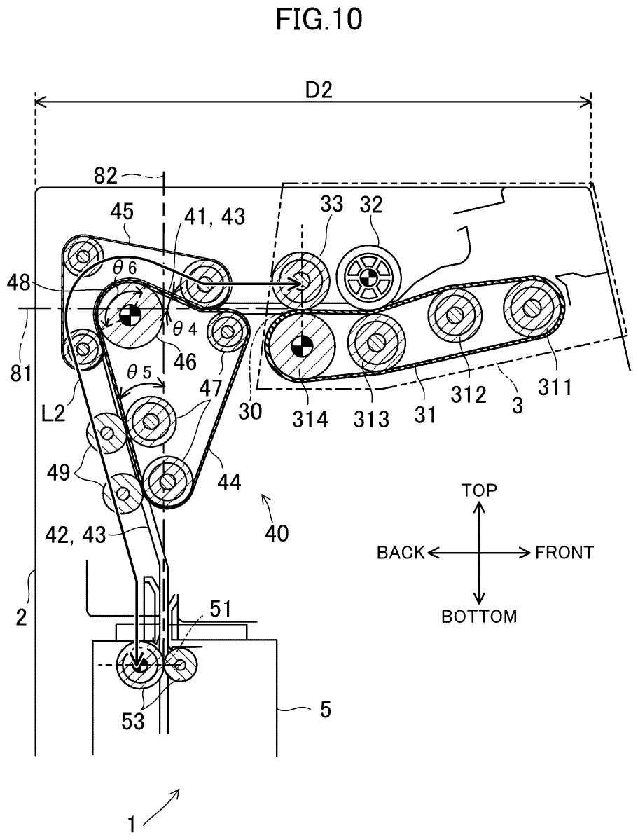

FIG. 10 shows a modification of the transport mechanism. A transport mechanism 40 according to the modification has the large pulley 46. The large pulley 46 is positioned on the back side with respect to the second reference line 82. The first reference line 81 overlaps with the large pulley 46.

The transport mechanism 40 has the transport path 43. The transport path 43 includes the first path 41 and the second path 42. The first path 41 includes a portion inclined, with respect to the first reference line 81, apart from the first passing port 51 while extending from the receiving port 30 to the first passing port 51. The inclination angle of the first path 41 is θ4. The second path 42 includes a portion inclined more inclined backward with respect to the second reference line 82 with an increase in a distance from the first passing port 51 of the recognition unit 5 in the upward direction. In other words, the second path 42 is inclined, with respect to the second reference line 82, apart from the receiving port 30 while extending from the first passing port 51 to the receiving port 30. The inclination angle of the second path 42 is θ5. The winding angle θ6 of the drive belt 44 around the large pulley 46 is 90° or more.

Each of the first path 41 and the second path 42 of the transport mechanism 40 is inclined. The length L2 of the transport path 43 is longer than the maximum length of a banknote to be handled by the sheet handling device 1. In the second withdrawal processing or the reconciliation processing as described above, a banknote can be stopped in the transport mechanism 4 between the inlet 3 and the recognition unit 5 in a state in which no drive force of the roller pair 53 of the recognition unit 5 acts on the banknote. Moreover, the length D2 of the housing 2 in the front-back direction is relatively short. Note that in a case where there is a time lag until the drive of the transport mechanism 40 is stopped after a banknote has passed the recognition unit 5, the length L2 of the transport path 43 may be a length obtained by addition of a distance at which the banknote moves during the time lag until the transport mechanism 40 stops.

### (Structure of Outlet)

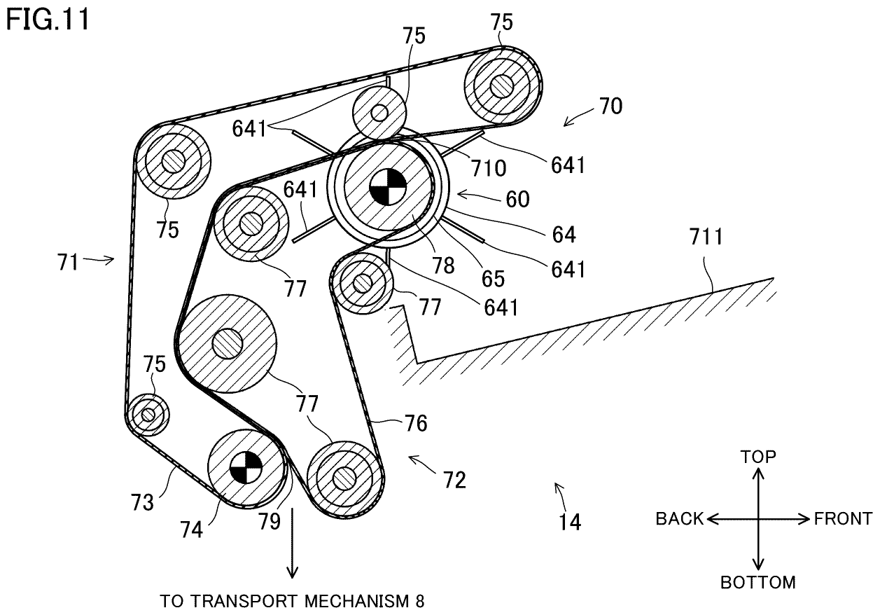

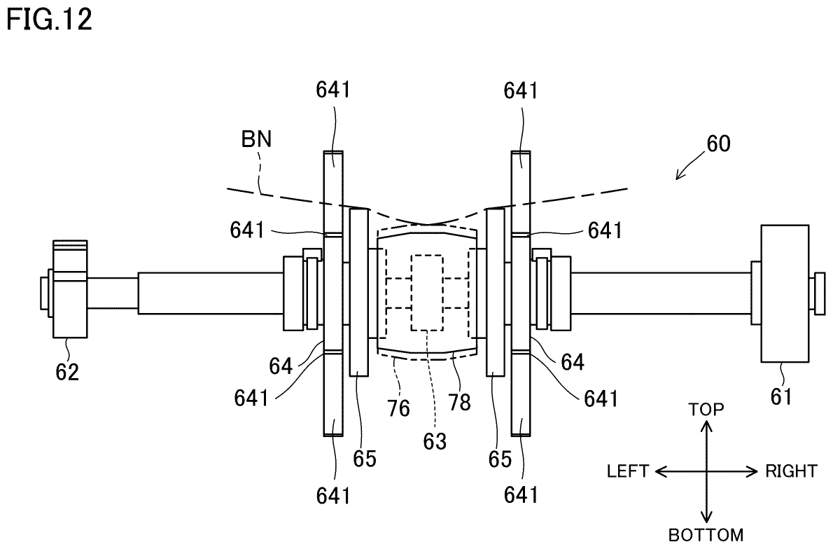

FIG. 11 shows the structure of the outlet 14. FIG. 11 is a sectional view of the outlet 14. FIG. 12 shows a rotating shaft 60 of the outlet 14. The outlet 14 has a dispensing mechanism 70. The dispensing mechanism 70 is connected to the transport mechanism 8. The dispensing mechanism 70 dispenses a banknote to the outside of the housing 2.

The dispensing mechanism 70 has a first belt mechanism 71 and a second belt mechanism 72. The first belt mechanism 71 is a drive belt mechanism. The second belt mechanism 72 is a driven belt mechanism driven by the first belt mechanism 71. The first belt mechanism 71 and the second belt mechanism 72 dispenses a banknote transported to the outlet 14 by the transport mechanism 8 to a tray 711. Banknotes are stacked in the tray 711.

The first belt mechanism 71 has a first belt 73 and pulleys 74, 75 around which the first belt 73 is wound. The pulleys 74, 75 are positioned such that the first belt 73 forms a transport path in a predetermined shape. Note that the pulley 74 is a drive pulley to which an electric motor is connected. The pulley 75 is a driven pulley.

The second belt mechanism 72 has a second belt 76 and pulleys 77, 78 around which the second belt 76 is wound. The pulleys 77, 78 are at predetermined positions such that part of the second belt 76 overlaps with the first belt 73. A first end 79 at a portion at which the first belt 73 and the second belt 76 overlap with each other is a connection end connected to the transport mechanism 8. A second end 710 at a portion at which the first belt 73 and the second belt 76 overlap with each other is a dispensing end from which a banknote is dispensed toward the tray 711. The second end 710 is one example of a dispensing port from which a sheet is dispensed to the outside of the housing 2. Note that the pulleys 77, 78 of the second belt mechanism 72 are all driven pulleys. The pulley 78 is supported on the rotating shaft 60 as described later. The dispensing mechanism 70 has the rotating shaft 60. The rotating shaft 60 is at the position of the second end 710. The rotating shaft 60 is coaxial with the pulley 78 of the second belt mechanism 72. As shown in FIG. 12, the rotating shaft 60 extends in the right-left direction. A pulley 61 is fixed to a first end of the rotating shaft 60. The pulley 61 is connected to an electric motor which is a drive source. The electric motor rotates the rotating shaft 60 in a first direction. The first direction is a direction in which a banknote is dispensed, and is the clockwise direction in FIG. 11. A one-way clutch is interposed between the pulley 61 and the rotating shaft 60. The one-way clutch connects the pulley 61 and the rotating shaft 60 to each other when the electric motor is driven in the first direction, and disconnects the pulley 61 and the rotating shaft 60 from each other when the electric motor is driven in a second direction. The second direction is the opposite direction of the first direction, and is the counterclockwise direction in FIG. 11. A one-way clutch 62 is attached to a second end of the rotating shaft 60. The one-way clutch 62 blocks the rotating shaft 60 from rotating in the second direction.

The pulley 78 of the second belt mechanism 72 is supported so as to rotate relative to the rotating shaft 60. More specifically, the pulley 78 is supported on the rotating shaft 60 through a radial bearing 63. The pulley 78 is rotatable even when the rotating shaft 60 stops, and is rotatable in both the first and second directions.

The dispensing mechanism 70 has banknote tapping wheels 64. The banknote tapping wheels 64 are fixed to the rotating shaft 60. The banknote tapping wheels 64 rotate in the first direction together with the rotating shaft 60. The two banknote tapping wheels 64 are spaced from each other in the right-left direction at a center portion of the rotating shaft 60. The pulley 78 is positioned between the two banknote tapping wheels 64.

The banknote tapping wheel 64 has a plurality of blades 641. The blade 641 is made of a material (e.g., rubber) having flexibility. The banknote tapping wheels 64 rotate, and accordingly, the blades 641 taps, into the tray 711, a back end portion of a banknote having passed between the first belt mechanism 71 and the second belt mechanism 72.

The dispensing mechanism 70 has stiffness imparting rollers 65. The stiffness imparting rollers 65 are fixed to the rotating shaft 60. The stiffness imparting rollers 65 are positioned between the banknote tapping wheels 64 and the pulley 78 at the center portion of the rotating shaft 60. The two stiffness imparting rollers 65 are spaced from each other in the right-left direction with the pulley 78 interposed therebetween. The stiffness imparting roller 65 has a diameter greater than that of the pulley 78. As indicated by a chain line in FIG. 12, the stiffness imparting rollers 65 bend the banknote BN transported along the second belt 76. The banknote BN bent by the stiffness imparting rollers 65 is stably dispensed from the second end 710 of the first belt mechanism 71 and the second belt mechanism 72.

In a case where a banknote is dispensed to the outlet 14, the first belt mechanism 71 is driven in the banknote dispensing direction, and the rotating shaft 60 is also driven in the banknote dispensing direction. All the pulley 78, the banknote tapping wheels 64, and the stiffness imparting rollers 65 supported on the rotating shaft 60 rotate in the banknote dispensing direction. The banknote tapping wheels 64 and the stiffness imparting rollers 65 are fixed to the rotating shaft 60 which is a drive shaft, and therefore, has a high banknote transport force. The dispensing end from which a banknote is dispensed toward the tray 711 is the second end 710 at which the first belt 73 and the second belt 76 overlap with each other. The first belt 73 and the second belt 76 overlapping with each other have a high transport force. For example, after an error due to banknote jam has been caused during the processing by the sheet handling device 1, a banknote in the middle of transport is dispensed to the outlet 14. At this time, the dispensing mechanism 70 can also dispense a jammed banknote to the outside of the housing 2 with a high transport force.

As described above, in the sheet handling device 1, in the second withdrawal processing or the reconciliation processing, the transport mechanism 8 and the outlet 14 included in the drive system D may be driven in the direction opposite to that in withdrawal in a state in which banknotes are stacked in the tray 711 of the outlet 14. In this state, there is a probability that when the banknote tapping wheels 64 and/or the stiffness imparting rollers 65 rotate in the opposite direction of the dispensing direction, the banknote tapping wheels 64 and/or the stiffness imparting rollers 65 lift the banknotes stacked in the outlet 14 and pull the banknotes into the housing 2.

On the other hand, the dispensing mechanism 70 is configured such that the rotating shaft 60 to which the banknote tapping wheels 64 and the stiffness imparting rollers 65 are fixed does not rotate in the opposite direction of the dispensing direction due to the one-way clutch 62. The banknotes stacked in the tray 711 are not pulled into the housing 2.

The pulley 78 supported on the rotating shaft 60 is rotatable relative to the rotating shaft 60. Even when the rotating shaft 60 stops, the pulley 78 is rotatable in the opposite direction of the dispensing direction. The first belt mechanism 71 and the second belt mechanism 72 are rotatable in the opposite direction of the dispensing direction, and therefore, the sheet handling device 1 can execute the second withdrawal processing and the reconciliation processing as described above.

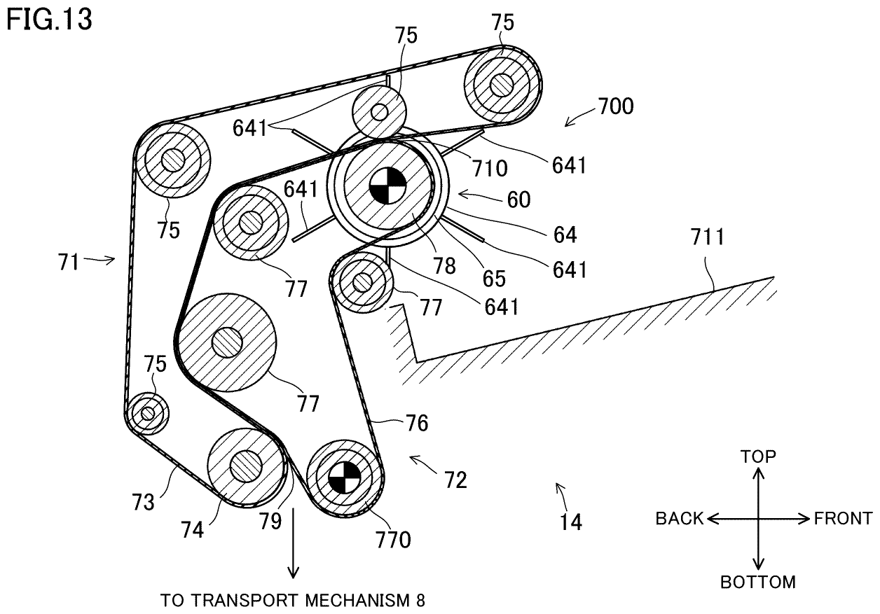

FIG. 13 shows a modification related to the dispensing mechanism. In a dispensing mechanism 700, the first belt mechanism 71 is a driven belt mechanism. The second belt mechanism 72 is a drive belt mechanism. In the example of FIG. 13, a pulley 770 of the second belt mechanism 72 is a drive pulley. Note that the drive pulley is not limited thereto. Note that the pulleys 74, 75 of the first belt mechanism 71 are all driven pulleys. As in the dispensing mechanism 70, the dispensing mechanism 700 can also maintain a high transport force. Moreover, the transport mechanism 8 and the outlet 14 included in the drive system D can be driven in the direction opposite to the dispensing direction without pulling the banknotes stacked in the tray 711 into the housing 2. The sheet handling device 1 can execute the second withdrawal processing and the reconciliation processing.

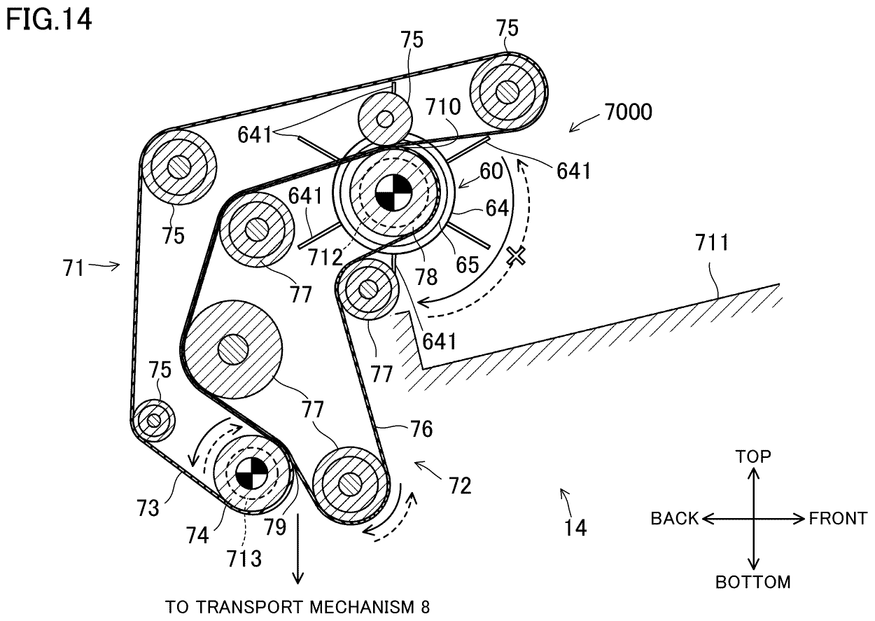

FIG. 14 shows another modification related to the dispensing mechanism. In a dispensing mechanism 7000, each of the first belt mechanism 71 and the second belt mechanism 72 is a drive belt mechanism. A first clutch 712 is interposed between the pulley 78 and the rotating shaft 60. In a case where the rotating shaft 60 rotates in the banknote dispensing direction, the first clutch 712 integrally rotates the rotating shaft 60 and the pulley 78.

Moreover, in a case where the pulley 78 is rotated in the opposite direction of the dispensing direction by the second belt 76, the first clutch 712 can rotate the pulley 78 relative to the rotating shaft 60. The pulley 78 is rotatable in the opposite direction of the dispensing direction, but on the other hand, the rotating shaft 60 does not rotate in the opposite direction of the dispensing direction.

A second clutch 713 is interposed between the pulley 74 of the first belt mechanism 71 and the electric motor. The second clutch 713 freely rotates the pulley 74 in a case where the first belt 73 runs in the banknote dispensing direction. The first belt 73 runs in a driven manner by the second belt 76. In a case where the pulley 74 is rotated in the opposite direction of the banknote dispensing direction, the second clutch 713 transmits the rotation force of the electric motor to the pulley 74. The first belt 73 runs in the opposite direction of the banknote dispensing direction by the electric motor.

In banknote dispensing, the rotating shaft 60 is rotated in the dispensing direction by the electric motor. With rotation of the rotating shaft 60, the pulley 78 rotates in the dispensing direction together with the banknote tapping wheels 64 and the stiffness imparting rollers 65. The pulley 78 rotates together with the rotating shaft 60, and therefore, the second belt 76 runs in the dispensing direction. The second belt 76 is a drive belt when a banknote is dispensed. The pulley 74 freely rotates, and therefore, in a case where a banknote is dispensed, the first belt 73 is a driven belt run by the second belt 76 (see a solid arrow in FIG. 14).

The electric motor of the first belt mechanism 71 rotates the pulley 74 in the opposite direction of the banknote dispensing direction (see a dashed arrow in FIG. 14). The first belt 73 is a drive belt in a case of running in the opposite direction of the dispensing direction. The electric motor of the rotating shaft 60 is stopped. The rotating shaft 60 does not rotate. Note that the first clutch 712 can rotate the pulley 78 relative to the rotating shaft 60. The second belt 76 runs in the opposite direction of the banknote dispensing direction in a driven manner by the first belt 73. In this case, the banknote tapping wheels 64 and the stiffness imparting rollers 65 fixed to the rotating shaft 60 do not rotate in the opposite direction of the dispensing direction.

As in the dispensing mechanism 70, the dispensing mechanism 7000 can also maintain a high transport force. Moreover, the transport mechanism 8 and the outlet 14 included in the drive system D can be driven in the direction opposite to the dispensing direction without pulling the banknotes stacked in the tray 711 into the housing 2. The sheet handling device 1 can execute the second withdrawal processing and the reconciliation processing.

Note that in the dispensing mechanism 7000, the electric motor of the rotating shaft 60 may be also used as the electric motor of the first belt mechanism 71. That is, one electric motor may be provided, and a one-way clutch may be interposed between the electric motor and the rotating shaft 60. In banknote dispensing, the electric motor rotates the rotating shaft 60 in the dispensing direction. The pulley 74 freely rotates, and therefore, the first belt 73 runs by the second belt 76. The electric motor rotates the pulley 74 in the direction opposite to the dispensing direction. The one-way clutch between the electric motor and the rotating shaft 60 blocks the rotating shaft 60 from rotating in the direction opposite to the dispensing direction. The pulley 78 rotates relative to the rotating shaft 60, and therefore, the second belt 76 runs in the opposite direction of the banknote dispensing direction in a driven manner by the first belt 73.

Note that the technique disclosed here is not limited to application to the above-described sheet handling device 1. The technique disclosed here may be applied to sheet handling devices with various configurations.

The first recycle container and the second recycle container may be stack-type storages that store banknotes with the banknotes overlapping with each other in the vertical direction.

One or both of the first recycle container and the second recycle container may recycle banknotes of plural denominations.

Three or more recycle containers may be provided. In the case of three recycle containers, six types of banknotes can be recycled at maximum.

The functionality of the elements disclosed herein may be implemented using circuitry or processing circuitry which includes general purpose processors, special purpose processors, integrated circuits, ASICs (“Application Specific Integrated Circuits”), conventional circuitry and/or combinations thereof which are configured or programmed to perform the disclosed functionality. Processors are considered processing circuitry or circuitry as they include transistors and other circuitry therein. The processor may be a programmed processor which executes a program stored in a memory. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

What is claimed is:

1. A sheet handling device comprising:
a receiving port that receives a sheet into a housing;
a transport mechanism that transports the sheet received into the housing through the receiving port; and
a recognition circuit that has a first passing port and a second passing port through which the sheet transported by the transport mechanism passes and recognizes the sheet passing the first passing port and the second passing port,
wherein the first passing port of the recognition circuit is positioned apart from the receiving port in a first direction,
the transport mechanism has a first path which is part of a transport path connecting the receiving port and the first passing port to each other, and
the first path is inclined, with respect to a first reference line extending in the first direction, apart from the first passing port while extending from the receiving port to the first passing port.

2. The sheet handling device of claim 1, wherein
the first direction is a horizontal direction, and
the first path is inclined upward.

3. The sheet handling device of claim 2, wherein
the first passing port is positioned lower than the receiving port.

4. The sheet handling device of claim 1, wherein
the transport mechanism has a second path extending continuously to the first path and extending in a second direction perpendicular to the first direction, and
the first passing port is connected to the second path.

5. The sheet handling device of claim 4, wherein
the second path is inclined, with respect to a second reference line extending in the second direction, apart from the receiving port while extending from the first passing port to the receiving port.

6. The sheet handling device of claim 4, wherein
a connection portion between the first path and the second path is apart in the first direction from the receiving port than the first passing port is from the receiving port.

7. The sheet handling device of claim 1, further comprising:
a storage that is connected to the second passing port of the recognition circuit and stores a sheet,
wherein the transport mechanism has a first drive system that transports a sheet on the transport path connecting the receiving port and the first passing port to each other and a second drive system that is provided independently of the first drive system and transports a sheet between the recognition circuit and the storage.

8. The sheet handling device of claim 7, wherein
the storage feeds out a stored sheet in a case where an inventory amount is uncertain,
the second drive system transports the sheet fed out from the storage to the second passing port, and the recognition circuit recognizes the sheet, and
the first drive system stops the sheet having passed the first passing port in a middle of the transport path between the recognition circuit and the receiving port until the recognition circuit outputs a recognition result.

9. The sheet handling device of claim 8, wherein
the first drive system transports the sheet to the first passing port after the recognition circuit has output the recognition result, and
the second drive system transports the sheet having passed the second passing port to the storage.

10. The sheet handling device of claim 9, further comprising:
a second storage that is connected to the second passing port, stores a sheet, and does not feed out the stored sheet,
wherein the storage performs first feeding of the stored sheet in a case where the inventory amount is uncertain, and
the second drive system transports the sheet related to the first feeding to the second storage after the recognition circuit has output a recognition result of the sheet related to the first feeding.

11. The sheet handling device of claim 7, further comprising:
a dispensing port that is connected to the second passing port and dispenses a sheet to an outside of the housing,
wherein the storage feeds out the stored sheet in a case where the sheet is dispensed to the dispensing port,
the second drive system transports the sheet fed out from the storage to the second passing port, and the recognition circuit recognizes the sheet, and
the first drive system stops the sheet having passed the first passing port in a middle of the transport path between the recognition circuit and the receiving port until the recognition circuit outputs a recognition result.

12. The sheet handling device of claim 11, wherein
the first drive system transports the sheet to the first passing port after the recognition circuit has output the recognition result, and
the second drive system transports the sheet having passed through the second passing port to the dispensing port.

13. The sheet handling device of claim 12, further comprising:
a second storage that is connected to the second passing port, stores a sheet, and does not feed out the stored sheet,
wherein the second drive system transports a sheet indicated as being not able to be dispensed by the recognition result to the second storage after the sheet has passed the second passing port.

14. The sheet handling device of claim 11, wherein
the second drive system transports a sheet recognized by the recognition circuit to the dispensing port in a first mode, and
the second drive system transports a sheet fed out from the storage to the dispensing port without transporting the sheet to the recognition circuit in a second mode.

15. A sheet handling method comprising:
feeding out, by a storage that stores a sheet, the sheet from the storage;
transporting, by a transport mechanism, the sheet fed out from the storage to a recognition circuit;
recognizing the sheet by the recognition circuit;
stopping, by the transport mechanism, the sheet at a position after the sheet has passed the recognition circuit until the recognition circuit outputs a recognition result, and
transporting, by the transport mechanism, the sheet in a reverse direction such that the sheet passes the recognition circuit after the recognition circuit has output the recognition result.
